(19) United States
(12) Patent Application Publication
(10) Pub. No.: US 2015/0039437 A1
(43) Pub. Date: Feb. 5, 2015

(54) Method of Coordinating Pre-scheduled Sales With Sellers and Buyers

(71) Applicant: Thomas J. Warner, Corvallis, OR (US)

(72) Inventor: Thomas J. Warner, Corvallis, OR (US)

(21) Appl. No.: 13/956,355

(22) Filed: Aug. 1, 2013

(51) Int. Cl. G06Q 30/02

(52) U.S. Cl. CPC G06Q 30/0264
USPC 705/14.61

(57) ABSTRACT

A method of buyer-seller interaction wherein multiple sellers agree to coordinate their individual sales in a coordinated sale is disclosed using a internet-based service. The individual sales within a coordinated sale are scheduled to start in succession. Sellers log onto a website interface for the service, and create a profile, including a listing of featured items for sale. A forum is available on the website where sellers may interact with each other to agree to establish a coordinated sale. The individual sellers desiring to participate in the coordinated sale coordinate the start times of the individual sales. Buyers may access the website to view the coordinated sale announcements, and view location, times and items for sale.

### FIELD OF THE INVENTION

The present invention relates to methods of coordinating sales events amongst multiple individual sellers and to advertise the advent of coordinated sales to potential buyers in order to form a synergistic selling environment that is mutually beneficial to the individual sellers by augmenting frequentation of the sales events by aware buyers.

### BACKGROUND

Frequently, local sales events are scheduled by a selling entity, such as a private seller offering goods for sale at common garage sales, yard sales, estate sales, travelling second hand vendors at hobby conventions and the like, to major department store chains offering special sales to the public. In many cases, certainly in the case of private sellers using a private home as a venue, there are few avenues available to advertise a sale to the general public. Moreover, on a given weekend, for example, there may be several sales independently and in competition with other sales planned in a neighborhood. The various sales may begin, or open to the public, at random times during the day, with varying hours of operation. Currently, there are various ways for buyers to find private sales via the internet. Websites exist for listing these, such as YardSaleSearch.com and Craigslist.org. Websites also specialize in listing estate sales, such as Family Estate Sale Solutions (familyestatesale.com). In some cases, the sales can be searched by location, and displayed on a map with information on the address, time and featured items.

However, the planned sales are not coordinated in any way, meaning a potential buyer may attend one garage sale to peruse the merchandise, while other garage sales may be taking place in the vicinity, but open to the public at earlier or later times in the day, or may open at the same time. The buyer must rove the neighborhood to find other garage sales if they have not consulted a listing service. If a sale is found that is already underway, the buyer may arrive late enough to have already missed the opportunity to find items of interest, as these items may have already been purchased by buyers who happened to be first on the scene. While the almost random hunt for bargains is a desirable aspect of garage sales, the search for private sales may be a time consuming and frustrating process due primarily to the randomness of the hours and locations. From a seller's perspective, having a larger number of people arrive at the start of the sale would increase the competition for the items in the sale and could have a positive impact when negotiating the sale price.

Ideally, a web-based service that is devoted to collecting time and place information from hosts of such sales and other private sellers can make life easier for interested buyers, in that by logging on to such a service they can organize their visits to private sales. The service may make the information available to the buying public by allowing buyers to log onto the service to retrieve time and place information on the sales. Moreover, a more powerful aspect of such a service would be one that provides a means to coordinate the timing of sales between willing sellers, wherein the willing sellers agree to stagger the start times of the sales to allow buyers time to better plan their time to visit sales in a successional and organized manner.

### SUMMARY

The present invention is an internet-based method to coordinate a plurality of geographically close but disparate individual sales events by coordinating said sales events in such a way that the sales events have coordinated start times that may be aligned to start in succession or in a staggered manner. The advantage and benefit realized by the present invention is to create a synergism amongst sellers choosing to participate in the coordinated sales event that is to the mutual benefit of the sellers. The present invention advantageously augments buyer attendance of the individual sales events whose starting times are aligned within the coordinated sales event, as said buyers may prefer to attend a plurality of sales events whose starting times are offset in a known manner. In this way, the buyers arrive at the individual sales event at the start, when the most items are available. Moreover, the preferred embodiment of the invention is a method of buyer-seller and seller-to-seller interfacing by means of a service managed by an internet website, or web-based service, wherein a platform is provided by means of the internet website or web-based service for two or more sellers to coordinate their sales into a single coordinated sale event, and advertise the coordinated sales event to potential buyers. In the preferred embodiment, the starting times of multiple individual sales events occurring in relatively close geographical proximity, such within the confines of a neighborhood, a community, or in multiple neighborhoods within a community or a town may be organized in such a way that they may start in succession, forming a chained sale. Alternatively, the plurality of individual sales events occurring in a relatively close geographical proximity may be organized in such a way that their starting times are staggered in a non-successive manner, but in such a way that any two starting times do not coincide. For example, the starting times of two or more individual sales events may be chosen to occur at random in a single day.

In a further embodiment, the seller may participate in a multi-day coordinated sale event. In this embodiment, a group of sellers who subscribe to the internet service may agree to hold their individual sales on a succession of days, instead of on a single day. This succession of two or more days may include a two-day, three-day or four-day weekend, as an example. There may be one or more sales scheduled for any single day of a multi-day coordinated sale. Again, the sellers who agree to hold their individual sales event on the same day of a multi-day coordinated sale may agree to stagger their individual sales so that the starting times do not coincide. The advantage to the seller of scheduling the start-times of the sales event is that buyers are given the opportunity to focus on one individual sale at a time. Advantageously, the inventive method provides for more buyers to arrive at the sale venue, such as the seller's private home, than would be the case for buyers randomly choosing particular sales venues to attend. Advantageously, the inventive method provides buyers with the opportunity to preview the items for sale, and have a first-come first-served time advantage over later arrivals as far as selection of the prime items that are offered at the particular sale.

The individual sales events comprise, and are not limited to, private sales events, such as yard or garage sales and estate sales, or public sales events, such as flea markets, art walks, and store sales. The inventive buyer-seller interfacing method comprises an internet-based service wherein sellers may subscribe by creating a profile. An individual seller may also use the service to advertise a singular private sales event, such as a yard or garage sale, wherein the seller may list the address and hours of the sale, including featured items to attract potential buyers who may consult the same service to find private sales events local to them. According to the preferred embodiment of the inventive method, the seller is presented with the option of participating in a coordinated sales event, wherein the internet-based service platform provides the seller with information of other yard or garage sales occurring on the same day as the seller has indicated, or within a set time period bracketing, or close to, the seller's initial choice of sales date. In this way, the seller may choose to change the original date of the sales event to join a coordinated sales event and coordinate with a common date agreed upon by other sellers who have already started a coordinated private sales event list. In this manner, the seller may agree with the other sellers who have signed up to a particular coordinated sales event on a start time for the seller's event, so as to establish staggered or offset start times of the sales of the coordinated sales event.

In a yet further embodiment, the inventive method provides for coordination of sales at flea markets and the like, where multiple individual vendors are gathered at a common venue. In this embodiment, individual sellers typically set up their merchandise for display at tables. In an manner analogous to the coordination of individual sales events in a neighborhood, the sellers at individual vendors may cooperate to form a coordinated sale at a common venue such as a flea market.

In yet a further embodiment, multiple coordinated sales events occurring within in geographical proximity may be presented to potential buyers in order to enhance their choice of buying opportunities. Buyers are shown, by graphical representation on the internet-based service platform, individual addresses of sales within a single coordinated sale. If more than one coordinated sale will be occurring simultaneously within a geographical proximity, the indicia representing addresses, for instance push pins on a Google map or other web-based map service, may be color-coded to distinguish the addresses taking part in one coordinated sales event from the addresses taking part in any of the other coordinated sale events occurring simultaneously.

### BRIEF DESCRIPTION OF THE DRAWINGS

FIG. 1. Depiction of a single coordinated sale flow.

FIG. 2. Depiction of a multiple coordinated sale flow.

FIG. 3. Flow chart of the inventive method according to the preferred embodiment.

FIG. 4. Interaction between buyers in sellers according to the inventive method.

### DETAILED DESCRIPTION

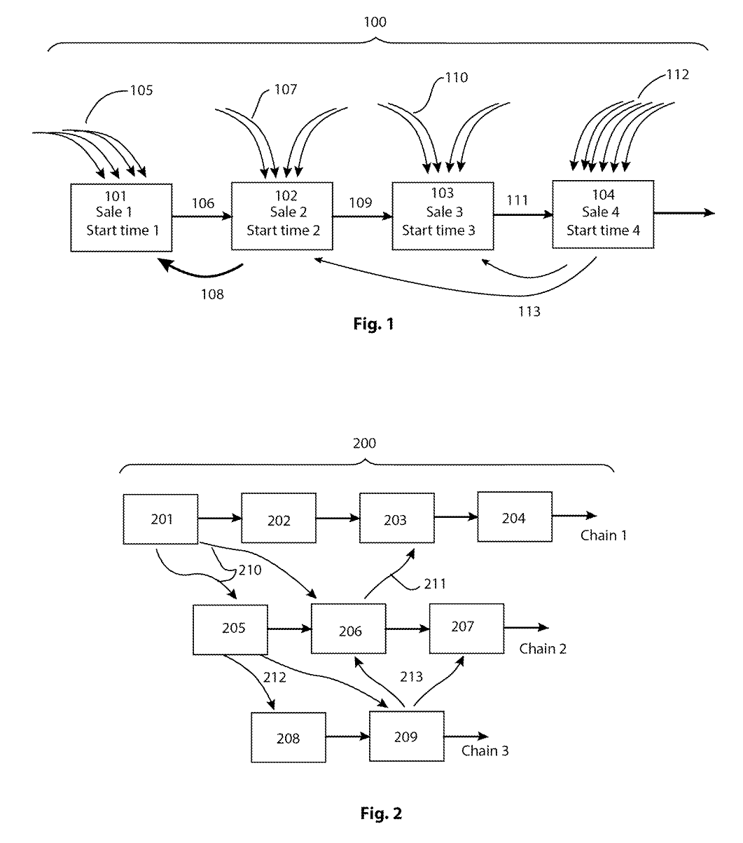

Referring to FIG. 1, the preferred embodiment of the invention is depicted, wherein the concept of a chained sale 100 is shown. Individual sales 101, 102, 103 and 104 are scheduled to start in succession, forward arrows indicating flow of buyers from one sale to the next. Arrows 105 represent buyers arriving at the first sale 101. Arrow 106 shows migration of some buyers from sale 101 to sale 102, with new arrivals 107 to sale 102. Buyers 108 may backtrack from sale 102 to 101. Other buyers 109 migrate from sale 102 to newly opened sale 103, with new arrivals 110 also attending sale 103. After some time, buyers 111 may choose to migrate to newly opened sale 104. In addition, new arrivals 112 may also attend sale 104. Some buyers 113 may choose to backtrack to any one of sales 103, 102 or 101.

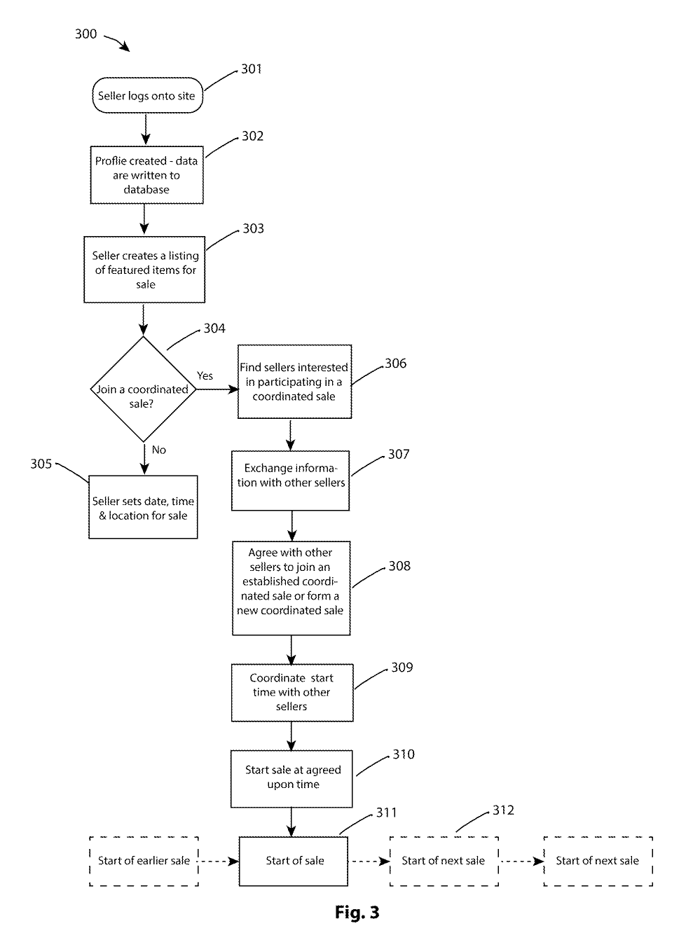

FIG. 2 shows an example of a multiple chained sale concept 200. Individual coordinated sale 1 (201-204), chain sale 2 (205-207) and chain sale 3 (208-209) occur on the same day. Buyers 210 may choose to migrate from chain sale 1 to chain sale 2, while buyers 211 may migrate from chain sale 2 to chain sale 1.

A flowchart 300 illustrating the method is shown in FIG. 3. Unregistered sellers 301 log onto the internet-based service platform host website provided to facilitate the inventive method and its embodiments, to register and create a seller profile. The website content is displayed on the client browser of the seller, whereby the website code such as the HTML code is stored in the computer memory of the remote server having an associated URL and downloaded from the website host to the client computer of the seller, whereby it is interpreted by the client web browser to display the website content on the client computer. All seller data is stored on a database residing in computer memory on the remote server website host.

A profile is created in step 302, while the seller may set up a listing on the web service for the proposed future sale in step 303. In the preferred embodiment, the seller opens a webpage that asks for input such as date of the sale, address and at least some of the items for sale. The data is stored in computer memory on the remote host server. An invitation 304 to join a coordinated sale on the web service is presented to the seller on the profile webpage. The seller has the option to join or not, and if the seller chooses not to join a coordinated sale, they may advertise for an individual independent sale event in step 305. If the seller is interested in joining a coordinated sale, he or she may then ask to see a listing of the other sellers that have opted to participate or have otherwise indicated a desire to participate in a coordinated sale event by making a request for a display of interested sellers on the same or a separate page of the website. The data on the sellers and associated individual sale event listings is retrieved from a listing database residing on the host server hard drive or loaded in memory.

The seller may view other listed individual sales, such as lawn or garage sales, listed by previously registered sellers not desiring to participate in a coordinated sale event. In the preferred embodiment, the newly registered sellers may obtain a listing of individual sale events that will be occurring in the geographical vicinity, wherein the host sellers desire to participate in a coordinated sale event (step 306). The sellers may exchange information amongst themselves (step 307) to potentially establish a new coordinated sale, and view previously established coordinated sales by geographic location and date, which may be open to be joined. Once agreement has been reached amongst the sellers to establish a coordinated sale (step 308), the sellers agree on start times to coordinate the coordinated sale (step 309). For an individual seller, the service may offer a space on the website to catalog sale items. The start time has been pre-arranged with the other sellers participating in a particular coordinated sale, and finally the coordinated sale takes place (step 310). Finally, the individual sale begins 311 in the previously arranged succession of coordinated sales 312. In another embodiment, the newly registered seller may request a listing of established chain sales for viewing. The new seller may choose to join a suitable coordinated sale event, for instance, one that is within a certain geographical locale, and will occur the same day or weekend the new seller plans to host his or her individual sales event.

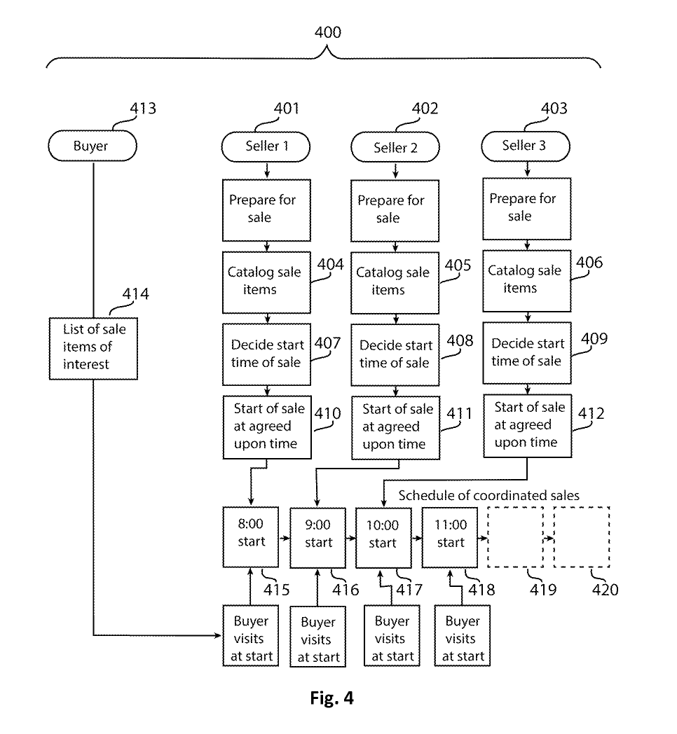

The buyer may have access to the catalog lists of items for sale that are offered by each seller, then chooses to visit each sale in succession, at the start of the sale, or in some other order. This is illustrated in FIG. 4, which shows an exemplary overall method of interaction 400 between multiple sellers and buyers in a coordinated sale according to the preferred embodiment of the invention. Sellers 401-403 may first catalog their respective sale items inventory in a database managed by the web service in a first step 404-406. The database for cataloging sale items inventories may be a separate web page made available to sellers listing their individual sales event with the web-based service of the internet site, and may make the inventories available to interested buyers. Sellers may then collectively agree on the start times for each of the individual sales events of each seller in a second step 407-409. This may be done by an exclusive “chat room” style instant messenger service on the website, or by e-mail exchange between interested sellers using external e-mail servers, or other means of contact external to the internet site, whereby a group of sellers interested in forming a coordinated sales event may communicate with each other. In the example depicted in FIG. 4, the sales are chained, whereby the start times are coordinated to occur in a successive manner according to the preferred embodiment. In a further step 410-412, each seller starts the individual sales event associated with that seller in succession. A buyer 413 who has accessed the inventory lists 414 for each of the individual sales events from the database managed by the internet site service may then proceed to visit each of the individual sales events of the coordinated sales in succession (415-420).

The foregoing embodiments are understood by persons skilled in the art to be exemplary in nature and in no way are intended to be construed as the ultimate limitations of the invention. Those skilled in the art will also understand that other embodiments and examples of deployment of the inventive method are conceivable and possible without departing from the scope and spirit of the invention, as claimed below.

I claim:

1. A method for creating a coordinated sale event, comprising:
(i) providing an internet site for sellers to register and advertise a sales event, said website constructed on a client computer by a client internet browser application residing in memory of said client computer as microprocessor-executable code;
(ii) registering as a seller on a registration page of said internet site by inputting site-requested seller data in data fields of a seller profile database, said seller profile database stored in computer readable memory on a remote server;
(iii) listing at least one future sale event by inputting website-requested data into a plurality of sales database fields on at least one input field page of said internet site, said database stored in computer readable memory on the remote server, wherein one of the database fields requires input to indicate seller's desire to participate in a coordinated sale event;
(iv) viewing a plurality of sale events by requesting data for other future sales to be displayed on at least one display webpage of said internet site, whereby said data are retrieved from a sales database stored in computer memory of the remote server by inputting a request to display the sales events on the at least one display webpage of said internet site;
(v) choosing at least one seller from a plurality of sellers associated with the plurality of sales events displayed on the at least one display webpage of said internet site that desires to coordinate his or her sale event with other sellers, whereby said at least one seller has a database field input indicating desire to participate in a coordinated sale event; and
(vi) coordinating the starting time of said seller's sale event with the starting time of one or more individual sale events to form a coordinated sales event, each individual sales event listed by the one or more sellers of a plurality of sellers associated with the plurality of sales events displayed on the at least one display webpage of said internet site, said one or more sellers desiring to coordinate their individual sales event with other sellers, whereby said one or more sellers have a database field input indicating desire to participate in a coordinated sale event.

2. The method of claim 1, wherein the method of creating a coordinated sales event further comprises the step of cataloging an inventory of sale items by adding said items to a database, said inventory database being accessible to interested buyers logged onto the internet site.

3. The method of claim 1, wherein the step of coordinating the starting time of said seller's sale event further comprises organizing the plurality of individual sales events in such a way that the starting times of each of the individual sales events of the plurality of individual sales events are scheduled to occur in a successive manner forming a chained sales event.

4. The method of claim 1, wherein the step of coordinating the starting time of said seller's sale event further comprises organizing the plurality of individual sales events in such a way that the starting times of each of the individual sales events of the plurality of individual sales events are scheduled to occur in a successive manner forming a plurality of chained sales events.

5. The method of claim 1, wherein the step of coordinating the starting time of said seller's sale event further comprises organizing the coordinated sales event into two or more subsets whereby the starting times of each subset are staggered, each subset consisting of at least one individual sales event, the at least one individual sales event being a portion of the total plurality of individual sales events comprised by the coordinated sales event, and whereby the starting times of the at least one individual sales events within each subset of the coordinated sales event occur simultaneously.
